(19) United States
(12) Patent Application Publication
(10) Pub. No.: US 2008/0284739 A1
(43) Pub. Date: Nov. 20, 2008

(54) Human Interface Device

(75) Inventors: Anton Oguzhan Alford Andrews, Seattle, WA (US); Thamer A. Abanami, Seattle, WA (US); Jeffrey Cheng-Yao Fong, Seattle, WA (US); Morgan Venable, San Francisco, CA (US); Thomas J. Misage, San Francisco, CA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/749,989

(22) Filed: May 17, 2007

(51) Int. Cl. G06F 3/041

(52) U.S. Cl. 345/173

(57) ABSTRACT

An input device may detect an input on an input device. The input may be compared to stored inputs to determine if the input is related to one of the stored inputs where the stored inputs can be user defined. If the input is related to one of the stored inputs, an action may be executed related to the stored input. If the input is not related to one of the stored inputs or is not recognized, the steps of the method may be repeated. The actions associated with different gestures may be defined by the user.

### BACKGROUND

This Background is intended to provide the basic context of this patent application.

The ability to quickly and reliably input information into a computing device been in existence since the development of computing devices. As computing devices have evolved into more specialized devices, more specialized input devices to work with the specialized devices have been developed. Instead of installing a complete keyboard, known options specific to the device may be explored by maneuvering in a north, south, east, west manner by selecting buttons that are north, south, east and west of a center point, which also may be selectable.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An input device may detect an input on an input device. The input may be compared to stored inputs to determine if the input is related to one of the stored inputs where the stored inputs can be user defined. If the input is related to one of the stored inputs, an action may be executed related to the stored input. If the input is not related to one of the stored inputs or is not recognized, the steps of the method may be repeated. The actions associated with different gestures may be defined by the user.

### BRIEF DESCRIPTION OF THE FIGURES

FIG. 1 is an illustration of the hardware in a sample device that could employ an input device;

FIG. 2 is a flowchart of a method of inputting on a device;

FIG. 3a is a side view of an input device with a switch beneath the input device;

FIG. 3b is an overhead view of an input device with a switch beneath the input device;

FIG. 4 is a illustration of an input device with two touch sensitive areas;

FIG. 5 is an illustration of an input device with an inner touch sensitive region and a ring of regions that operate mechanical switches;

FIG. 6a is an illustration of a touch sensitive pad that has four separate touch regions;

FIG. 6b is an illustration of a touch sensitive pad that has nine separate touch regions;

FIG. 7a is an illustration of a cross section of a flat touch sensitive input pad;

FIG. 7b is an illustration of a cross section of a touch sensitive input pad with raised edges;

FIG. 7c is an illustration of a cross section of a touch sensitive input pad with varying width;

FIG. 8 is an illustration of a touch sensitive input device with five switches; and

FIG. 9 is a illustration of a swipe across different regions of the input device.

### DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

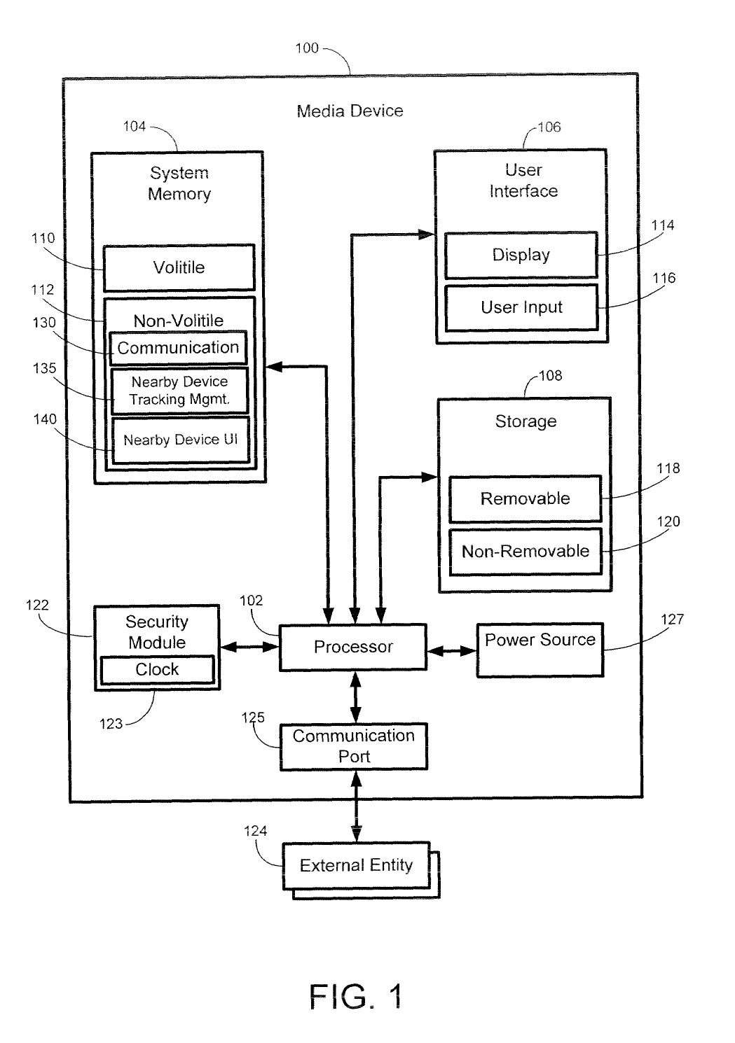

FIG. 1 is an illustration of exemplary hardware that may be used for a device 100 that may use an input device. The device 100 may have a processing unit 102, a memory 104, a user interface 106, a storage device 108 and a power source (not shown). The memory 104 may include volatile memory 110 (such as RAM), non-volatile memory 112 (such as ROM, flash memory, etc.) or some combination of the two or any other form of storage device The device 100 may also include additional storage 108 (removable and/or non-removable) including, but not limited to, magnetic or optical disks or tape or any other memory. Such additional storage is illustrated in FIG. 1 by removable storage 118 and non-removable storage 120. Computer storage media includes volatile and nonvolatile, removable and non-removable media implemented in any method or technology for storage of information such as computer readable instructions, data structures, program modules, digital media, or other data.

The processing unit 102 may be any processing unit 102 capable of executing computer code to decode media data from a compressed format into a useable form fast enough such that music and video may be played continuously without skips or jumps. When in a portable media device, it may also be useful if the processor 102 is efficient in using power to increase the life of the power source. The processing unit 102 may also be used to execute code to support a user interface and external communications.

The user interface may include one or more displays 114 for both displaying control information and displaying viewable media. The display 114 may be a color LCD screen that fits inside the device 100.

The device 100 may also contain communications connection(s) 122 that allow the device 100 to communicate with external entities 124, such as network endpoints or a communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media

The power source 127 may be a battery that may be rechargeable. The power source 127 may also be a standard battery or an input from a power converter or any other source of power.

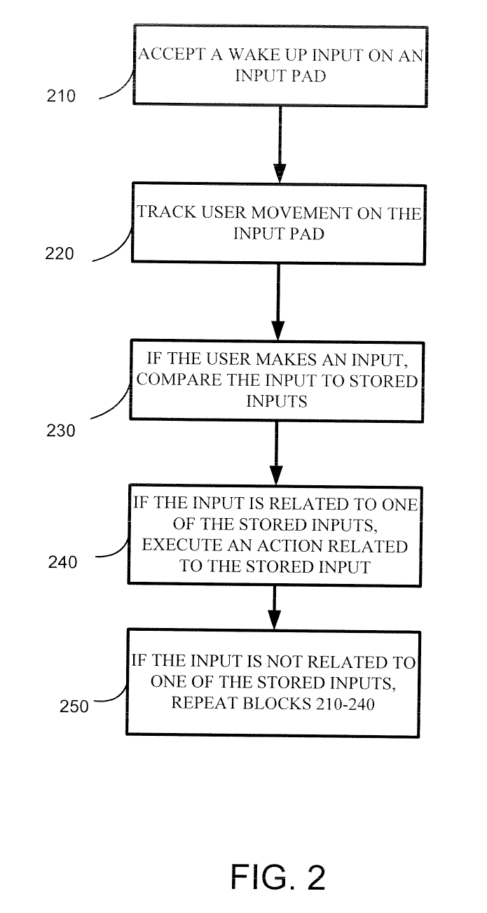

FIG. 2 is a flowchart of a method inputting on a device 100. The device 100 may be any device 100 that accepts inputs. In one embodiment, the device 100 is a portable media player and in another embodiment, the device 100 is a remote control. Of course, additional embodiments are possible.

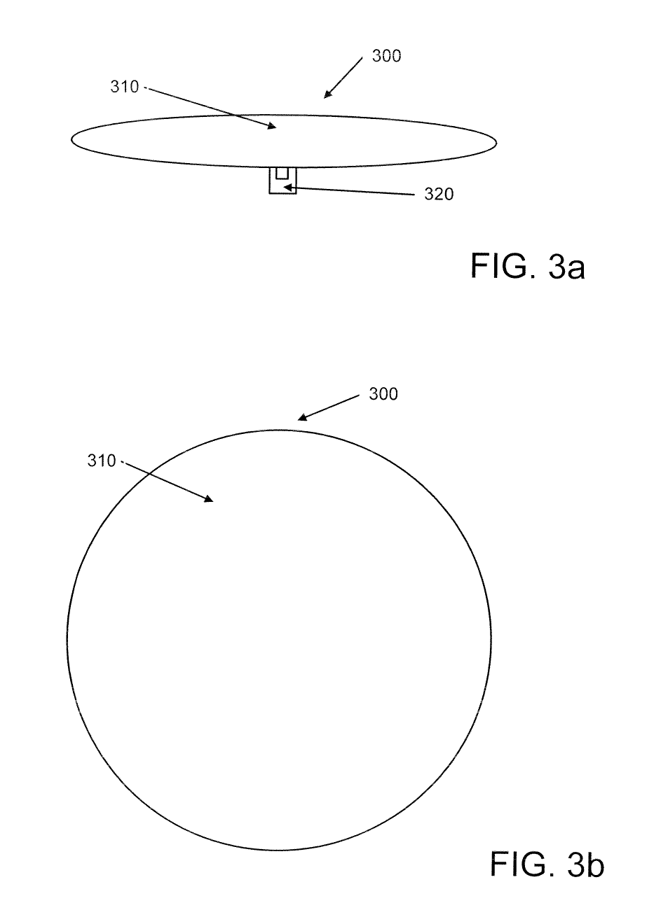

At block 210, a wake up input on an input pad may be accepted. In one embodiment, the input device 300 (FIG. 3a) has two states. In a first state, the input device 300 is asleep or locked. A first input only wakes up the input device 300 to enter in the second state. Once in the second state, inputs are used to take actions. In use, a first touch of the input device 300 will “wake up” the input device and once the input device 300 is awake, it will enter the second state and accept inputs for actions. In this way, inadvertent touches of the input device 300 will not result in unintended actions. In addition, consumption of the power source may be reduced by not having the device take extensive actions in response to an inadvertent touch of the input device 300. By only taking extensive actions when the actions are desired, power consumption may be better controlled. In another embodiment, a separate dedicate button is used to “wake up” the input device 300 from the first state and enable it to enter the second state where inputs for actions may occur. In another embodiment, a specific action on the input device 300′ may “wake up” the input device 300 such as a double tap, a swipe or any other action. The “wake up” action also may be programmed by a user.

FIGS. 3a, 3b, 4 and 5 are illustrations of an input device 300 and the input device 300 may be a form a of the input device 116 (FIG. 1). The input device 300 may be a touch sensitive device such as a capacitive surface that can sense and track physical contact on and across the input device 300. In one embodiment, the input device 300 is a circular disk such as illustrated in FIG. 3. In another embodiment, the input device 300 is shaped like a diamond and in another embodiment the input device 300 is shaped like a square. The input device 300 may be virtually any shape. The input may be made using virtually any object, such as a finger, a fingernail, a glove, a pointing device such as a stylus, a pencil or any other device capable of actuating the sensors in the input device 300.

In one embodiment, the input device 300 has an input pad 310 that is a touch sensitive surface that is mounted over a switch 320. FIGS. 3a and 3b are illustrations of one such arrangement where FIG. 3a is a side view and FIG. 3b is an overhead view. Some touch sensitive surfaces 310 may not operate as desired when touched with an object such as a pencil as opposed to a finger. For example, the touch sensitive surface 310 may be a capacitive surface that reacts to touches by grounded objects, such as a finger, and objects that are insulators and cannot provide a ground, such as a pencil or a long fingernail, may not result in touches being sensed by the touch sensitive surface 310. In these situations, it may be desirable to have a physical switch under the touch sensitive surface 310. In another embodiment, the touch sensitive surface 310 is a resistive surface.

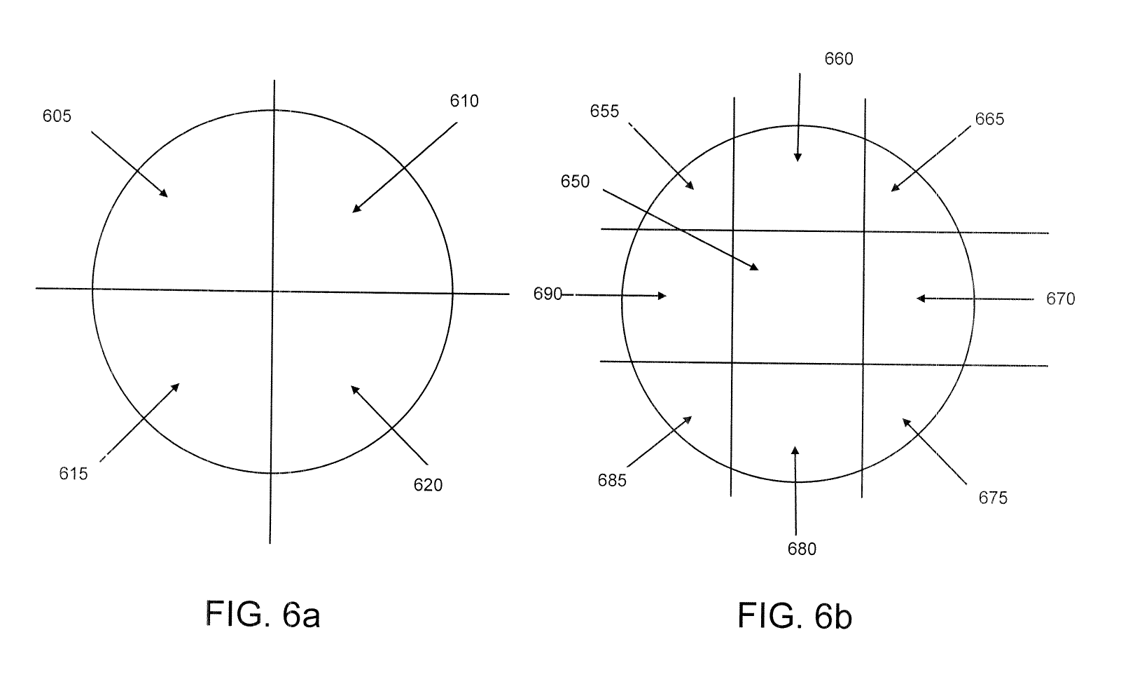

In one embodiment, there is a single switch 320 under the input pad 310. However, by tracking the location of the input on the input pad 310, the activation of the single switch 320 may activate numerous actions. Referring to FIGS. 6a and 6b, the input pad 310 may be broken into regions. When the switch 320 is activated, the location that is currently being touched on the input pad 310 may be noted. Referring to FIG. 6a, activating the switch 320 from region 605 may result in a first action, activating the switch 320 from region 610 may result in a second action, activating the switch 320 from region 615 may result in a third action and activating the switch 320 from region 620 may result in a fourth action. Referring to FIG. 6b, the input pad 310 may be broken into even more regions such as the nine regions 650-690. By combining the location of the touch on the touch pad 310 at the time that the switch 320 was activated, multiple switches may be replicated while only having a single switch 320.

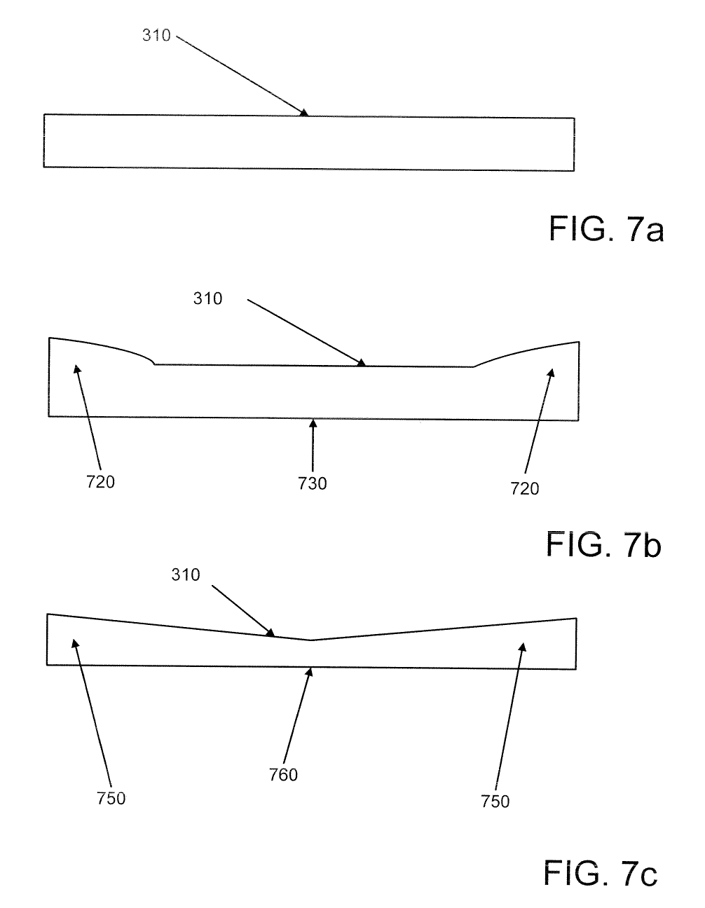

The surface of the input pad 310 may have numerous configurations. FIG. 7a illustrates a profile view of an embodiment of an input pad 310 where the input pad 310 is flat. FIG. 7b illustrates a profile view of an embodiment of an input pad 3110 where the input pad 310 has raised or rolled edges 720 and a relatively flat inner area 730. FIG. 7c illustrates a profile view of an embodiment of an input pad 310 where the input pad 310 becomes narrower at the center 760 and wider at the outside edges 750. The embodiments illustrated in FIGS. 7b and 7c may allow a user to better orient where the user is touching the input pad 310 without having to look at the pad 310. By feel, the user may be able to tell when they are touching the edges of the input pad 310 as the input pad 310 will have a rise or a roll that may be noticed by the user.

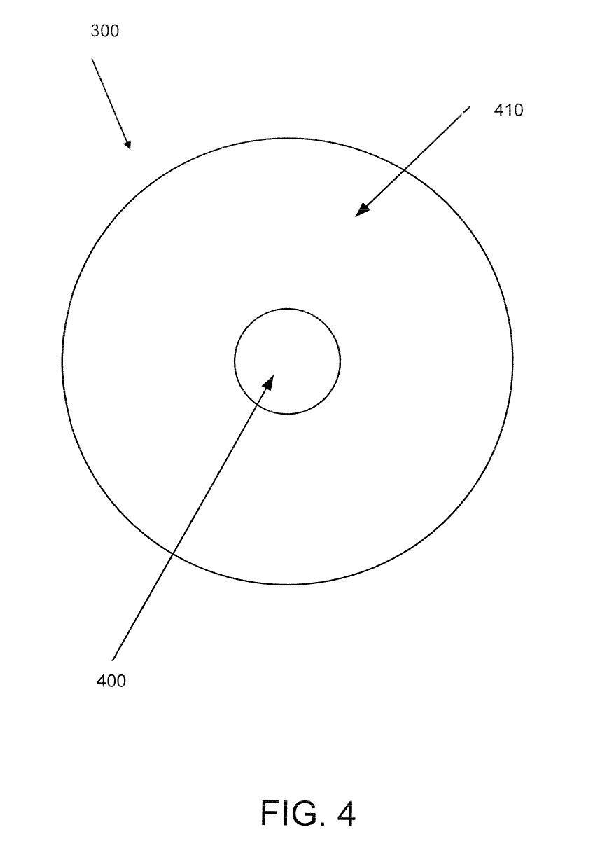

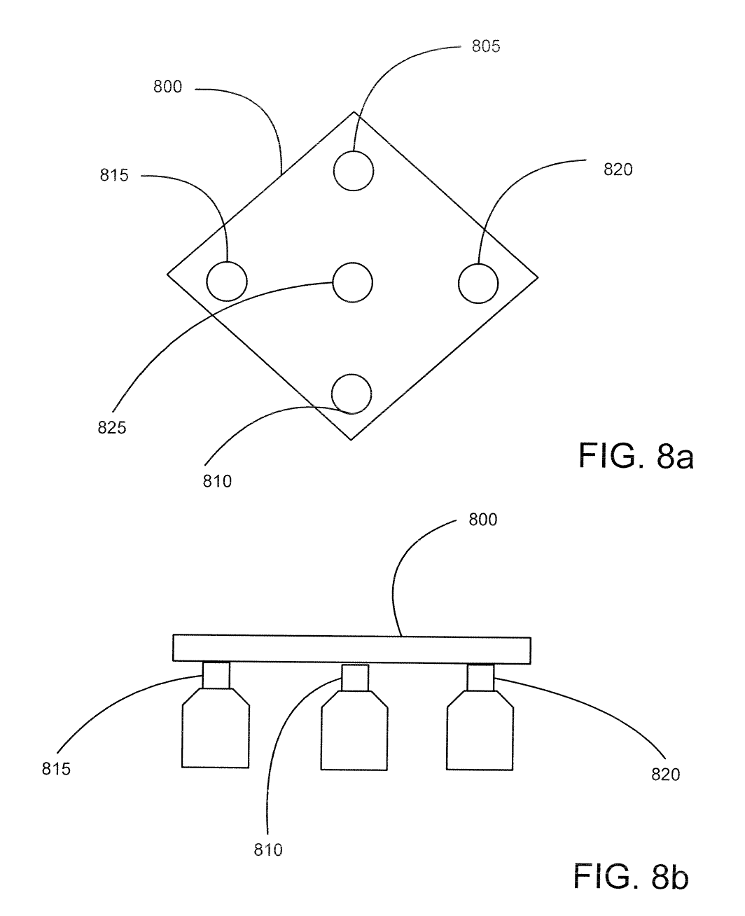

Referring to FIG. 4, in another example, the input device 300 may have an inner area 400 and an outer area 410. The inner area 400 may be touch sensitive, the outer area 410 may be touch sensitive or both the inner 400 and outer areas 410 may be touch sensitive. There may be switches under the inner area 400, under the outer 410, or under both the inner area 400 and outer area 410 such as illustrated in FIG. 8.

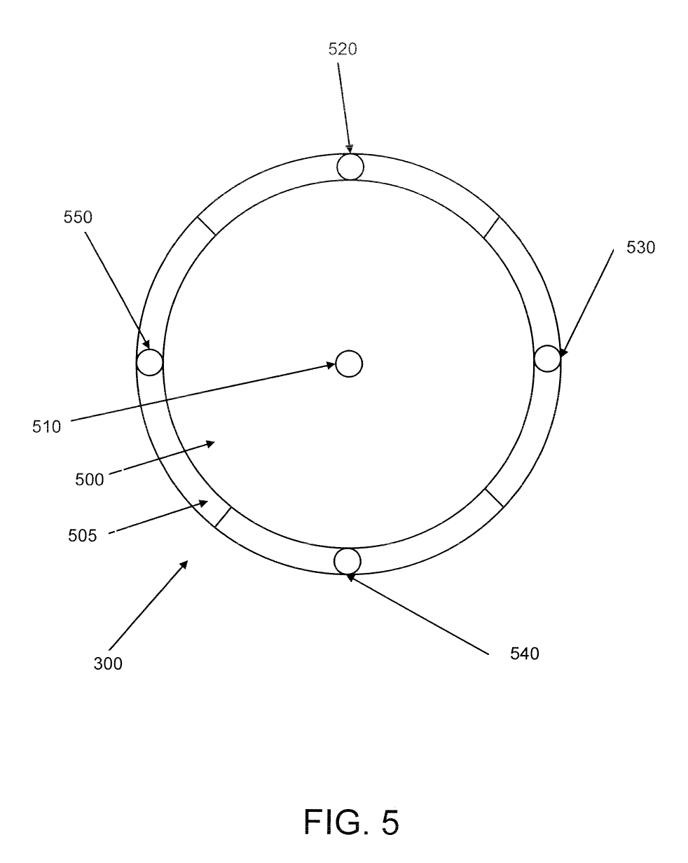

Referring to FIG. 5, in another example, the input device 300 may have a larger inner area 500 and a thinner outer ring 505. The inner area 500 may be touch sensitive and may have a switch 510 underneath. The outer ring 505 may be separated in separate depressible buttons. In the example in FIG. 5, the outer ring is broken into four pieces and each piece has a switch under them 520, 530, 540, 550.

In another embodiment such as in FIGS. 5a and 8b, there are five switches under the touch pad 310, such as in a north 805, south 810, west 815, east 820, center 825 arrangement. As a result of such a design, some touches will actuate the touch sensitive surface 310 and actuation of the physical switches will not be necessary. In other situations, such as when the touch sensitive surface 310 does not register the contact from a pencil, pressing further on the input device 300 will actuate the physical switches 805, 810, 815, 820, 825 and selections will be made as desired.

In addition, in some embodiments, the input device 300 is a display device 114. An OLED display is capable of being shaped in a variety of shapes, can detect inputs and can be mounted in a way to allow the entire input device 300 to be selectable. The input device 300 may be the display 114 or may be a separate display just for receiving inputs. In one embodiment, the input device 300 displays the actions associated with each area of the input device 300 and the display changes as the function of the device changes. For example, referring to FIG. 6b, if the device is a remote control, in a television mode, an area 670 east (north on top) from a center point of the input device 300 may be related with a change channel up function and the words “channel up” may be displayed in this area. In a DVR mode in FIG. 6b, the east area 670 from a center point of the input device 300 may be related with a fast forward function and the words “fast forward” may be displayed in this area.

An input may take on a variety of forms. The input may be a tap on the input device 300, a series of taps on the input device 300 or the input may be a movement on the input device 300. The input may be on a specific area of the input device 300 that has been previously designated as having a specific purpose. In addition, additional areas of the input device 300 may be defined as having actions associated with them. Referring to FIG. 6b, depending on the use of the device, multiple input areas may be defined on the input device 300 beyond the traditional north 660, south 680, west 690, east 670, and center 650 input areas of FIG. 6a. Defining areas may be accomplished through an application that assigns locations on the input device 300 to defined input areas. For example, the one centimeter square between the north and west corners 665 of the input device 300 may be a known area and touches to this area may be related to an action.

Areas on the input device 300 may be defined by the application operating on the device 100. For example, if the device 100 is a game controller for a baseball game, the different areas of the input device 300 may indicate different areas that receive pressure when pitching a baseball which may result in different pitches. Accordingly, there may be significantly more than five input areas on the input device 300 for the baseball game.

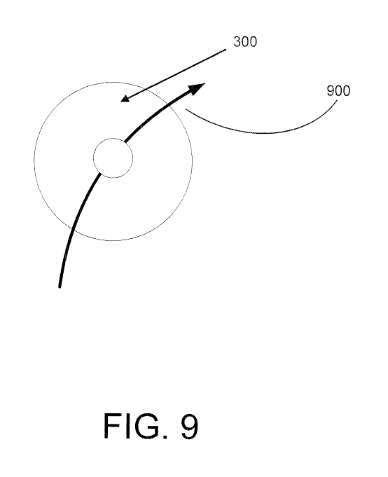

A gesture on the input device 300 may be acceptable. Referring to FIG. 9, an upward movement 900 on the input device 300 on a portable media player 100 may indicate a desire to increase volume. Common gestures may be accommodated such as the tracing of letters. As an example, when reviewing a menu of music on a music player, a user traces the letter of the song desired and the list of songs skips to the letter traced on the input device 300. Of course, the form of the input may be many and varied.

Inputs may also be user defined. A selection may allow a user to associate a tap in an input area, a series of taps in one or more input areas, or a swipe (or movement) across the input device 300 such as illustrated in FIG. 9 to be associated with an action and store the data related to the input as an acceptable input. The input areas may be the standard five input areas (north, south, east, west and center) or additional input areas on the input device may be defined.

In the embodiment where the input is a swipe 900, the determination of the desired input may be more complex. The data related to the swipe may be reviewed as the input moved across the input device 300 over a period of time. The data related to the direction of the swipe 900 along with the data representing the path or shape of the swipe 900 may be compared to stored direction and swipe data to determine if the swipe 900 is sufficiently similar to stored swipes, including user defined swipes. If the swipe 900 is recognized, the action related to the swipe may be executed. If the swipe 900 is not recognized, no action may be taken or a list of the closest swipes and the related actions may be displayed to a user and the user may be able to select the desired swipe.

In addition, if a swipe 900 of the letter “p” is not recognized and a user indicates that the swipe was meant to represent the letter “p,” future swipes that have a similar direction and shape to the swipe 900 in question may be assigned as swipes 900 of the letter “p.” In this way, the device 100 may learn and future swipes may better understood. Of course, other factors may be used to determine if swipes are similar to stored swipes, such as the velocity and acceleration of the swipe, etc. The input may also provide additional information than the mere selection of an action.

Referring to FIG. 9, in one embodiment, the velocity and acceleration of a swipe 900 across the input device 300 is measured and provides guidance to the device 100 regarding the desire of the user. For example, when scrolling through a menu of songs on a portable media device 100, a quick downward motion may result in an accelerated scan through the songs stored on the portable media device 100. If the input device 300 is mounted on a game controller 100, a fast swipe may indicate a hard punch in a boxing game, a hard throw in a baseball game, a long throw in a football game, etc.

Referring again to FIG. 2, at block 220, user movement on the input device 300 is tracked. The movements may remain in a memory until there is an indication that the movement has changed, stopped, moved off the input device 300 or otherwise ended.

At block 230, if the user makes an input, the input is compared to stored inputs. In the case where the input device 300 has the standard five input field orientation (north, south, west, east, center), a tap in any of these areas may be quickly recognized as being a selection of these areas and the action associated with each area. If the tap is between two areas, the device may provide a notification that the input was not understood or the device may do nothing as the input was not inside a specific area. Also, as previously explained, the input action may take on a variety of forms, from pushing on the input device to activate one or more switches under the input device 300 to a swipe in the shape of a letter.

At block 240, if the input is related to one of the stored inputs, an action may be executed related to the stored input. Once an input is defined, it may be associated with an action to be completed when the defined input is received. The actions may be presented to the user as a pick-list of options or the user may define a series of actions to be the action associated with the input similar to a macro in a word processing program. The action may apply to all programs or applications that operate on the device 100 or may be defined to only apply to one or more specific programs or applications.

At block 250, if the input is not related to one of the stored inputs, the steps of the method may be repeated. In other words, the device 100 may take no action, ignore the not understood input and wait for another input. Additionally, the method may provide a notification that the input was received but did not match any known input. An option may be provided to allow a user to associate an action with the not-understood input. The actions may be provided from a list of known actions or the user may be able to define a new action to be executed when the not-understood input action occurs.

Feedback may be provided on the device 100 that the input was received. The feedback may take different forms that may create a notification to one of the senses that the input was received. For example, the feedback may be a noise, a vibration or a notification on the display 114, or a combination thereof. In order to provide a noise, a speaker such as a peizo-electric speaker may be part of the device 100 and may provide a noise, such as a click, when an item is selected. A vibration or haptic feedback may also be provided by a peizo electric device which may vibrate the entire device 100 or just the input device 300. Notifications on the display may be created using software that is executed by the device.

The feedback may be related to the type of input received by the input device 300. A brief tap may result in a haptic feedback such as a brief shake of the device 100 or the feel of a click. A swipe 900 (FIG. 9) across the input device 300) may result in a rumble of the device 100. The feedback may also relate to the mode of the device 100. The device 100 may be capable of multiple actions ranging from playing a baseball game to making telephone calls and these actions may be thought of as modes. For example, if the device 100 is a telephone that also has games and the device 100 is playing a baseball game (baseball game mode), the feedback may be sounds related to a baseball game. If the user is swinging at a baseball, the feedback may be the simulated feel of a bat hitting a ball. If the device 100 is in telephone mode, an input that is used to dial a phone number from a plurality of phone numbers (phone mode) may provide sounds of a dialing telephone rather than sounds from a baseball game.

The feedback may also relate to the action selected by the user. For example, the user may use the input device 300 to provide an input to select to swing a bat in a baseball game. The feedback may relate to the action of swinging the bat such as a swinging bat (possibly hitting the ball), or providing haptic feedback of the bat swinging at the ball.

The feedback may also be programmed by the user. Again, assuming the device 100 is a game controller and the device 100 is playing a college football game, a fight song for the particular college football team may be added by the user. The feedback may be added by accessing a module of the device 100 and selecting to download the fight song in a variety of ways, such as using a wireless connection to connect to a web site with fight songs for download. The manner of downloading objects, including vibration producing objects, to be used on the device 100 are known and any manner of downloading are possible such as server-client, peer-to-peer, FTP, etc.

Another option may allow the user to use the device 100 to design custom feedback for an application. The device 100 may have an application that lists the available feedback options and permits a user select the desired available feedback option for the desired action. In addition, a user may be permitted to create custom feedback options by, for example, selecting the amount, length or intensity of the feedback. In addition other forms of feedback are possible.

In all the embodiments, the input data and related action data may be stored locally such as in memory 108 or remotely. The device 100 may have wireless and/or wired communication capabilities and additional data related to input data and action data may be accessed from remote sources as well as internal sources. Internal source may be accessed first and if matching data is not located, additional data may be accessed at remote sources. In addition, a user may be able to direct the device to look to outside network sites for additional data related to the input device, the available actions, etc.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

1. A method of inputting on a device comprising
accepting a wake up input on an input pad;
tracking user movement on the input pad wherein the input pad is actuated by applying a touch to the input pad;
if the user makes an input, comparing the input to stored inputs wherein the stored inputs are user definable;
if the input is related to one of the stored inputs, executing an action related to the stored input; and
if the input is not related to one of the stored inputs, repeating the steps of the method.

2. The method of claim 1, further comprising determining a location of touch when the input is made and executing an action previously related to the location of the input.

3. The method of claim 1, further comprising allowing a user to define the input and assign the action related to the input.

4. The method of claim 1, wherein the input device is a touch sensitive device.

5. The method of claim 1, wherein if the input is not related to one of the stored inputs, providing feedback that the input was not related to one of the stored inputs.

6. The method of claim 1, wherein feedback is provided related to the input.

7. The method of claim 6, further comprising if the input is a depression of the input device, providing click feedback.

8. The method of claim 1, wherein the input comprises a location of contact on the input device and an actuation of a switch.

9. The method of claim 8, wherein the location of contact is used to create a plurality of input regions.

10. The method of claim 1, wherein the feedback is provided through the input device.

11. The method of clam 6, wherein the feedback is definable.

12. The method of claim 1, wherein the input is a motion from a first point on the input device to a second point on the input device.

13. The method of claim 1, wherein the input device is a display device.

14. The method of claim 13, wherein feedback is provided by displaying feedback on the input device.

15. The method of claim 1, wherein the action related to the input is dependent on a mode of the device.

16. The method of claim 1, wherein the feedback is dependent on a mode of the device.

17. An electronic device comprising:
a touch sensitive input device comprising an input surface that senses touch;
an input surface frame for supporting the input device
a feedback device in communication with the input surface frame;
a processor in communication with the input device;
a memory in communication with the processor;
the processor being programmed to execute computer executable instructions for
detecting an input on the input device;
using the feedback device to provide definable feedback on the input device that the input was received;
comparing the input to stored inputs to determine if the input is related to one of the stored inputs wherein the stored inputs can be user defined; and
if the input is related to one of the stored inputs, executing an action related to the stored input.

18. The electronic device of claim 17, further comprising computer executable instructions for allowing a user to define the input and assign the action related to the input.

19. A computer storage medium comprising computer executable instructions for:
detecting an input on the input device;
comparing the input to stored inputs to determine if the input is related to one of the stored inputs wherein the stored inputs can be user defined;
using the feedback device to provide definable feedback on the input device that the input was received wherein the feedback is related to the action executed; and
if the input is related to one of the stored inputs, executing the action related to the stored input.

20. The computer storage medium of claim 19, further comprising computer executable instruction for determining a mode of the device and executing an action related to the input for the determined mode.
